(19) United States
(12) Patent Application Publication
(10) Pub. No.: US 2017/0217361 A1
(43) Pub. Date: Aug. 3, 2017

(54) Optical Warning Illumination Array

(71) Applicant: Jeffrey James Miller, Dravosburg, PA (US)

(72) Inventor: Jeffrey James Miller, Dravosburg, PA (US)

(21) Appl. No.: 15/013,484

(22) Filed: Feb. 2, 2016

(51) Int. Cl. B60Q 1/22; B60Q 1/26; F21V 14/06; G02B 5/18; H05B 37/02

(52) U.S. Cl. CPC B60Q 1/22; G02B 5/1842; G02B 5/1814; H05B 37/0218; H05B 37/0227; F21V 14/06; B60Q 1/2615

(57) ABSTRACT

An optical warning illumination device includes a light pattern generator for generating and projecting a light pattern on the ground. The light pattern is comprised of a plurality of images. The device includes a mounting member for mounting the light pattern generator to a vehicle and to position the light pattern generator with respect to the vehicle. The device includes a controller for controlling the operation of the light pattern generator.

### BACKGROUND

1. Field

The present invention relates to an optical warning device for vehicles and, more particularly, to an optical warning illumination array mounted to a vehicle.

2. State of the Art

According to the National Institute for Highway Safety (NIHS), twenty percent of all auto accidents happen in commercial parking lots. “Backover” injuries to pedestrians—injuries to pedestrians where cars back-up and hit pedestrians—are among the most serious injuries. Almost three hundred backover fatalities occur every year. Minor injuries include whiplash, cuts, bruises, and swollen muscles, tendons, or ligaments. Such auto accidents are mostly due to both the driver and pedestrian not paying attention to the presence of one another. In other words, there is a lack of situational awareness of drivers and pedestrians.

Many passenger cars have back-up cameras and/or back-up sensors that warn the driver of the car of potential hazards. An Insurance Institute for Highway Safety (IIHS) study shows that rear cameras are more effective than parking sensors at helping drivers avoid objects while traveling in reverse, but they don't help in every situation. Parking sensors only alert the driver of obstacles and are very effective at reducing property damage accidents. However, back-up cameras and parking sensors do not provide any warning to pedestrians or other vehicular traffic to make them situationally aware of the movement of the backwards-moving vehicle (also referred to as a “reversing” vehicle). Back-up (or “reversing”) lights provide the only currently available external indication that a car is in reverse. However, reversing lights can be ineffective at alerting pedestrians and other vehicle traffic, especially during the day, because those lights are directional in nature and are relatively low intensity.

The Occupational Safety and Health Administration (OSHA) estimates that there are 110,000 fork truck (also called “forklift”) accidents each year causing approximately 31,600 employees to suffer some type of injury. The immediate economic cost of fork truck accidents is estimated to be about $135 million a year. About nineteen percent of forklift accidents occur when a forklift strikes a pedestrian. Moreover, it is estimated that approximately every three days, someone in the United States is killed in a forklift related accident. Indeed, one in six workplace fatalities in the United States are forklift related. According to OSHA, approximately seventy percent of all accidents reported are avoidable.

As shown in FIGS. 1 and 2, some industrial fork trucks 100 currently use a blue LED spotlight 102 when traveling in reverse to project a single blue spot 104 (about twelve inches in diameter) on the ground 106 at a location that is approximately fifteen to twenty feet behind the fork truck 100 to warn pedestrians 108 (FIG. 1) and other fork trucks (not shown) of the presence of the fork truck. If positioned on the back of the fork truck 102, the blue LED spotlight 102 turns on when the fork truck 100 is placed in reverse.

There are several issues with the above-mentioned blue LED spotlight 102. For example, there is no standard that fixes the focusing distance of the light spot 104 behind the fork truck 100. Indeed, the relative distance between the blue spot 104 on the ground 106 and the fork truck 100 can vary widely within a fleet of fork trucks. Therefore, the location of the spot 104 on the ground may not reliably inform the pedestrian 108 (FIG. 1) or other vehicle around the truck about the relative distance between the blue dot 104 and the fork truck 100, especially if multiple fork trucks 100 operate in a facility (e.g. a warehouse) where each truck has a differently adjusted spotlight 102.

Also, to be effective, the blue LED light 102 requires situational awareness on the part of the observer (pedestrian/other fork truck traffic) to actually observe the spot 104 on the ground 106. The relatively small size of the blue spot 104 on the ground 106 (approximately twelve inches in diameter) limits visibility and effectiveness in warning people around the fork truck 100. Typically, the spot 104 may be projected from an elevated position on the fork truck 100 and so it is possible that the spot 104 is projected over the head of a pedestrian who is located between the back of the fork truck 100 and the blue spot 104. Thus, in such a situation, the blue spot 104 may be completely outside the field of vision of a pedestrian. In that regard, it is noted that most reversing accidents between fork trucks and pedestrians occur within the first ten feet of travel of the fork truck. Therefore, for example, if a pedestrian is located eight feet away from a reversing fork truck and the blue spot is projected fifteen feet away from the fork truck and behind the pedestrian, the blue spot may not be seen by the pedestrian to warn him or her of the movement of the fork truck, rendering the blue spot useless as a warning to the unwary pedestrian.

### SUMMARY

According to one aspect, an optical warning illumination device includes a light pattern generator for generating and projecting a light pattern on the ground. The light pattern is comprised of a plurality of images. The device includes a mounting member for mounting the light pattern generator to a vehicle and to position the light pattern generator with respect to the vehicle. The device includes a controller for controlling the operation of the light pattern generator.

The device generates a light pattern on the ground that has a light gradient so as to provide a warning from the vehicle (e.g., from the back of the vehicle) all the way out to a certain distance (e.g., fifty feet), depending on the positioning of the system relative to the vehicle. In one embodiment, the light pattern includes an array of a plurality of illuminated images projected on the ground adjacent to the vehicle (e.g., behind the vehicle). The images may be dots spaced along the ground along the direction of travel of the vehicle. The spacing between images may be a function of the distance of the image from the device that is mounted to the vehicle. In one embodiment, the images may be formed in shapes of circular dots, although other shapes are possible, including ovals, stars, squares, chevrons, triangles, letters, words, etc. The projected light pattern may provide a proximity warning to a pedestrian or other vehicle in the vicinity of the projecting vehicle. For example, densely spaced projected images that are nearer the back of the vehicle can be an indicator to a pedestrian that that area of the light pattern is relatively close to the vehicle, while less densely spaced projected images that are nearer the opposite end of the projected area can be an indicator to a pedestrian that that area of the light pattern is relatively far from the vehicle, thus providing an indication to the pedestrian a visual indicator of how far away the approaching vehicle is from the pedestrian's position in the pattern.

The device is configured for mounting on vehicles, such as cars and forklift trucks, to give clear and present warning to pedestrians and other motorists that a vehicle is moving in a certain direction (e.g., reverse) and may be approaching their position.

### BRIEF DESCRIPTION OF THE DRAWINGS

FIG. 1 is an illustration of a prior art fork truck projecting a blue light spot onto a walkway.

FIG. 2 is a schematic illustration of a prior art fork truck with a blue LED spotlight mounted thereto.

FIG. 3 is a plan view schematic illustration of fork truck and pedestrian traffic where the fork trucks are fitted respectively with an embodiment of an optical warning illumination device.

FIG. 4A illustrates a plan view of a light pattern projected onto the ground from the optical warning illumination device of FIG. 3.

FIG. 4B illustrates a plan view of another light pattern projected onto the ground from the optical warning illumination device of FIG. 3.

FIG. 5A is a schematic illustration of an embodiment of an optical warning illumination device.

FIG. 5B is an illustration of images projected by the device of FIG. 5A at an initial time, and FIG. 5C is an illustration of images projected by the device of FIG. 5A at a later time after the initial time.

FIG. 6A is a schematic illustration of another embodiment of an optical warning illumination device.

FIG. 6B is a schematic illustration of an alternative embodiment of an optical warning illumination device to that shown in FIG. 6A.

FIG. 7 illustrates a plan view of a light pattern projected onto the ground from another embodiment of an optical warning illumination device.

FIG. 8 is a schematic illustration (plan view) of a car equipped with an optical warning illumination device backing out of a parking lot parking space into pedestrian and vehicle traffic.

FIG. 9 is a partial side view of the schematic illustration of FIG. 8.

FIG. 10 is a schematic illustration (plan view) of a car equipped with an optical warning illumination device backing out of a driveway into pedestrian and vehicle traffic.

### DETAILED DESCRIPTION

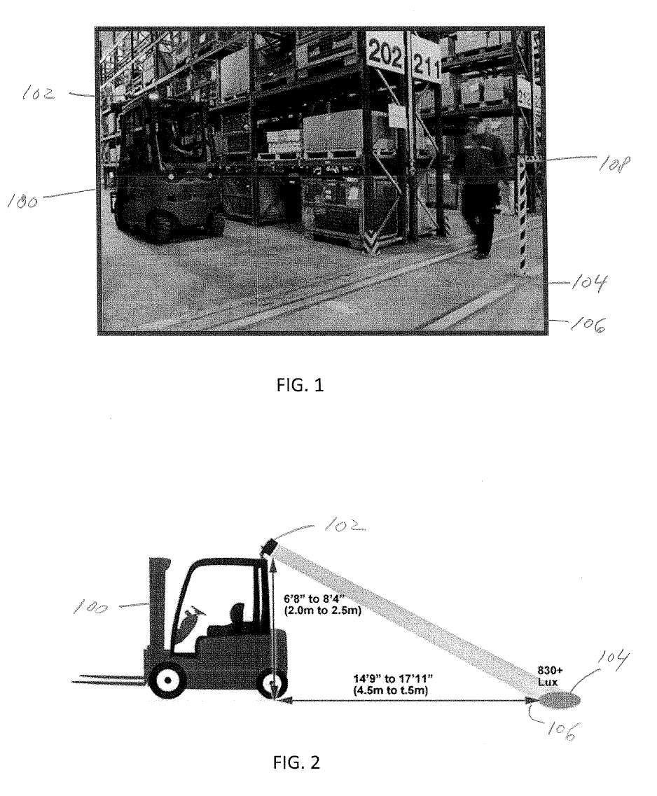

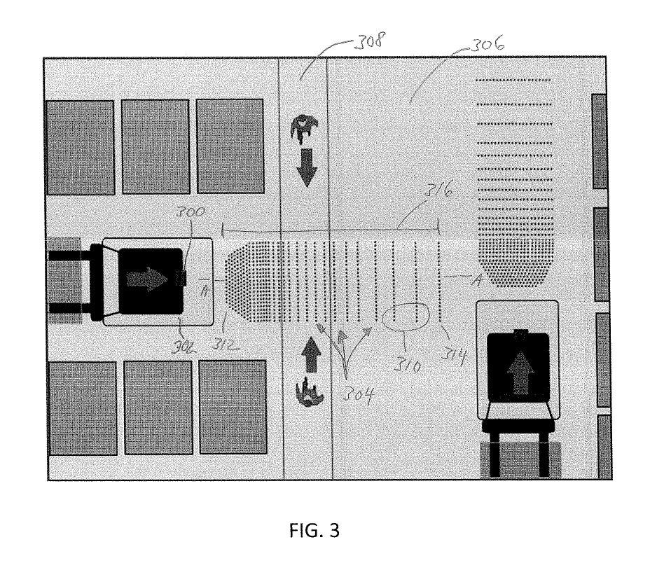

FIG. 3 shows an optical warning illumination device 300 mounted to a fork truck 302. The device projects a light pattern 304 on the ground 306 in the direction of travel of the fork truck 302, which is behind the fork truck 302 in FIG. 3. In FIG. 3 the light pattern 304 extends in a longitudinal direction (e.g., a reversing direction of the fork truck) along axis A, from near the rear of the fork truck 302 and crossing a pedestrian pathway 308. It is noted that the term “near” the rear of the vehicle is intended to mean within one-half the vehicle length of the rear of the vehicle, and could be between a couple of inches and a few feet from the vehicle. The light pattern 304 shown in FIG. 3 includes a plurality of images 310 that are spaced from each other along the axis A from a first end 312 near the rear end of the vehicle 302 to a second end 314 at a predetermined distance from the rear of the vehicle 302. Thus, rather than a single projected spot 104 being projected on the ground 106 in FIGS. 1 and 2, the device 300 in FIG. 3 projects a plurality of spaced images 310 (e.g., spots) on the ground 306 across a span between the first end 312 and the second end 314. Owing to the light pattern 304 extending across that span 316, even a pedestrian that is located within the span 316 can be made situationally aware of the pattern 304 and that the fork truck 302 is moving towards the pedestrian.

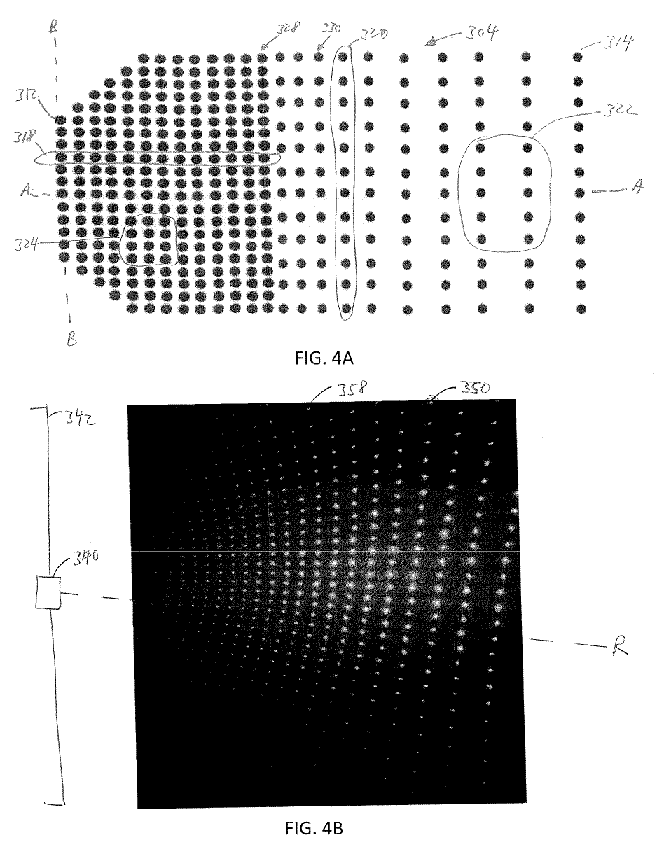

A more detailed view of the light pattern of images is shown in FIG. 4A. In FIG. 4A, the images 310 are shown as being circular dots that are arranged in a Cartesian grid array having a plurality of rows 318 and columns 320 that are orthogonally arranged. While dots are shown in the example in FIG. 4A, it will be appreciated that many other shapes may be projected including ovals, stars, triangles, chevrons, arrows, letters, words, and squares. Also, the images 310 may include distance markers or numbers indicating a distance measurement from the marker to the vehicle. Each column 320 of spots extends in a transverse direction that is parallel to an axis B, which is perpendicular to axis A. In one embodiment the dot pattern spacing may be between 0.1 inch to 72 inches, and each dot projected on the ground has a diameter of at least 0.1 inch.

In one embodiment, multiple columns 320 extend a certain distance that is about equal to the width of the fork truck 302. The dots 310 are spaced from each other along both the longitudinal and transverse directions. The longitudinal spacing between the columns 320 increases with increasing distance from the first end 312, thereby creating a light gradient in the pattern 304. The increase may be in steps between groups of columns as suggested by FIG. 4A or may be more gradual. The gradient of images 310 may provide an indication of proximity between the moving fork truck 302 and other objects. For example, an area 322 in the light pattern 304 having larger spacing between spots 310 indicates a position that is relatively farther away from the fork truck 302 than another area 324 in the pattern 304 having smaller spacing between spots 310.

Also, the transverse spacing between the dots 310 within each column may vary based on distance from the first and second ends 312, 314 of the light pattern 304. For example, as shown in FIG. 4A, in the area 324 the transverse spacing between dots 310 is relatively small, and in the area 322 the transverse spacing between dots 310 is relatively larger. Thus, the light pattern of dots 304 may be seen to spread out longitudinally and transversely as distance increases from the first end of the pattern so that the images are more densely spaced near the first end 312 than at the second end 314 of the pattern 304.

In one example, a fork truck equipped with the device 300 has a width of about 49 inches and the device 300 projects the pattern 304 of FIG. 3 on the ground. In the example it is assumed that all of the spots 310 have the same dimensions. In the example, there are 21 spots in column 328, and 12 spots in column 330 and all of the columns are assumed to extend the full width of the fork truck. Moreover, in the example it is assumed that the transverse spacing between the 21 spots 310 in column 328 are about one-quarter of the diameter of each spot 310. Therefore, in the example, each spot 310 has a diameter of about 2.0 inches and the transverse spacing between spots in column 328 is about 0.5 inch and in column 330 is about 2.5 inches. Also, the longitudinal spacing next to spots 310 in column 328 is about 1.3 inch and the spacing next to spots 330 in column 320 is about 3.2 inches.

While the spots 310 are shown in FIG. 4A as being arranged in orthogonally arranged rows and columns in a Cartesian coordinate system, in another embodiment the spots 310 may be arranged in radially spaced arcs in a polar coordinate system where each arc has a different radial position from the optical warning illumination device 300. An example of such a pattern of spots 350 arranged in arcs 358 is shown in FIG. 4B. For correspondence with the description of the pattern of FIG. 4A, even though the spots 350 in each arc 358 in FIG. 4B are not arranged in a straight line, for purposes of this discussion, each arc 358 will be considered as forming a curved column that spans substantially the width of a vehicle 342 on which the device 340 is mounted. Also, in FIG. 4B, rows of spots 350 may be defined as spots intersecting a common radius, R from the device 340. In each row the radial spacing between adjacent curved columns or arc 358 may increase with increasing distance away from the optical warning illumination device 340, as shown, for example, in FIG. 4B.

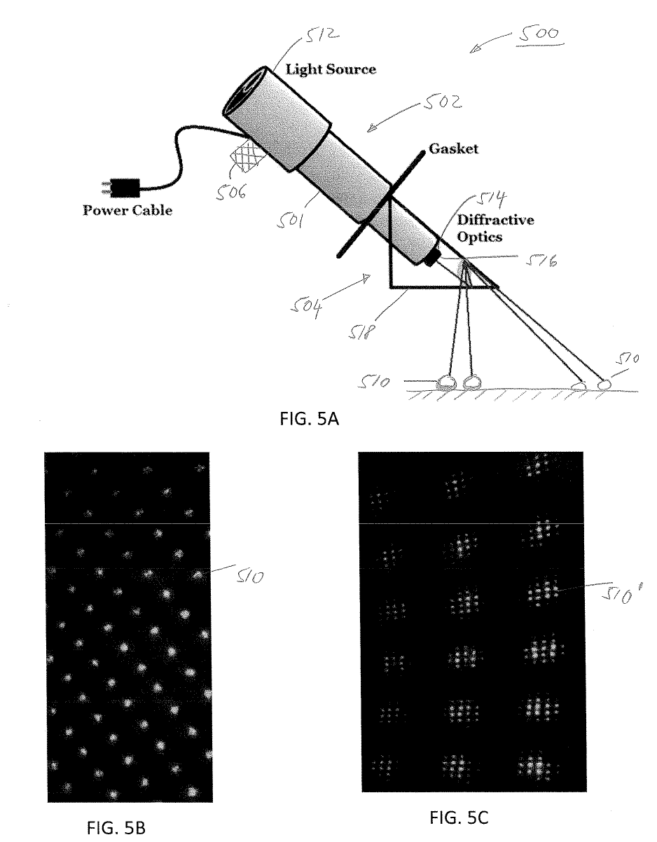

FIG. 5A shows an embodiment of optical warning illumination device 500 that is configured to generate a plurality of images 510. The device 500 includes one or more light pattern generators 502, a mounting member 504, and a controller 506. The light pattern generator 502 is configured to generate a pattern of the images 510 on the ground 508. The mounting member 504 is configured to attach the light pattern generator 502 to a vehicle (not shown) and to position the light pattern generator 502 with respect to the vehicle. The controller 506 is coupled to the light pattern generator 502 and is configured to control its operation for generating the pattern of images 510 on the ground 508.

In one embodiment, the light pattern generator 502 includes a light source 512 and optics 514 optically coupled to the light source 512 to projected the images 510 on the ground 508. The light source 512 may include one or more electrically powered lasers having a power output range e.g., of between 0.01 mW to 10 W. Also, while not shown, in another embodiment, laser energy emitted by such laser light source may be directed onto a set of mirrors, which may focus the laser energy into a phosphorous filled lens, which in turn may emit intense light. Such intense light may be directed behind the vehicle 342 and viewed safely by an observer without risk of retinal injury. The optics 514 may include a diffraction plate with a diffraction grating (not shown) corresponding to the images of the light pattern to be projected onto the ground. The diffraction plate may be comprised of a glass or polymeric material with a diffraction grating etched or otherwise formed into the plate. When power is supplied to the laser 512, light emitted therefrom passes through the diffraction grating in the diffraction plate to project the pattern of images onto the ground. The diffraction plate may be attached via epoxy, glue, or other means to a rotating lens cover 516 that is connected to the light pattern generator 502. A small motor (not shown) may also be coupled to the lens cover 516 to rotate the lens cover 516 so that when the lens cover 516 rotates, the projected images 510 spin and change in shape, size, or location on the ground behind the vehicle, thus providing an additional means of alerting surrounding pedestrians and motorists of the presence and movement of the vehicle to which the device 500 is mounted. The images 510 spin and the diffraction patterns change as a result of the light patterns falling into and out of coherence. The spots 510 move into and out of each other in such a way that it can be eye-catching to an observer. FIG. 5B shows an example of images 510 projected at an initial time. FIG. 5C shows images 510′ projected at a later time after which the images have been rotated and have changed in shape.

The light pattern generator 502 and the controller 506 of the device 500 may be housed in a common housing 501. The mounting member 504 may include a bracket 518 for mounting the light pattern generator 502 to a vehicle so that the device 500 does not obstruct the view of the operator of the vehicle. As shown in FIG. 5A, the mounting bracket 518 may contain weather gaskets/seals to prevent moisture and water from entering the housing 501. While only one light pattern generator 502 is shown in FIG. 5A, the mounting bracket 518 may contain a plurality of mounting elements to allow for multiple light pattern generators 502 to be secured to the bracket at various angles.

Optionally, the mounting member 504 may include a motor or linkage (not shown) that adjusts the position of the light pattern generator 502 with respect to the vehicle to which it is mounted. For example, the mounting member 504 may include a motor (not shown) that is configured to move the bracket 518 to direct the light pattern generator 502 in the direction of travel of the vehicle as the operator of the vehicle turns the steering wheel. In one example, a steering wheel sensor (not shown) may be used to detect the position of the steering wheel of the vehicle, and the output of that sensor can be used as an input to the motor to adjust the position of the light pattern generator 502 with respect to the vehicle.

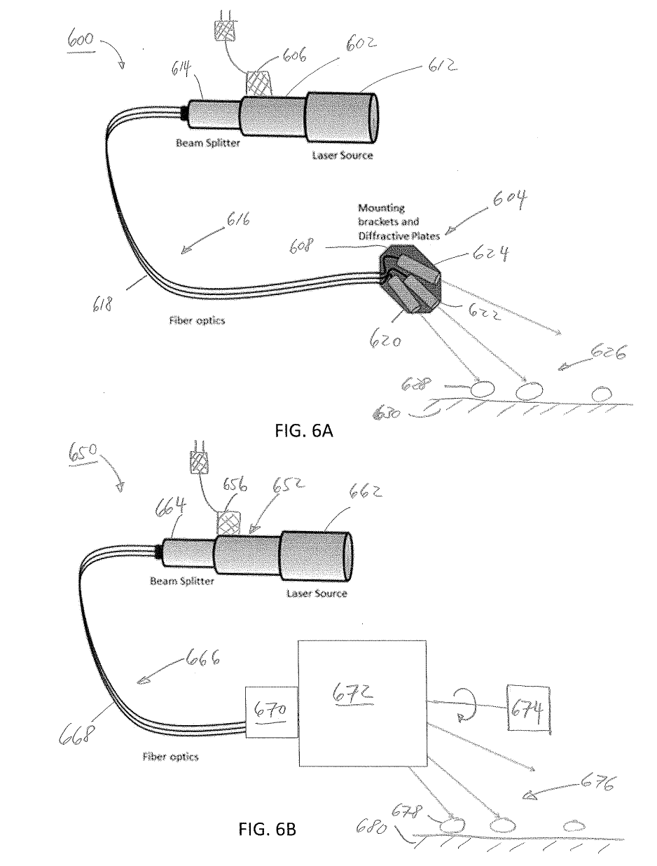

FIG. 6A shows another embodiment of an optical warning illumination device 600, which may be advantageous for mounting the device 600 in a vehicle with space constraints. The device 600 includes a light pattern generator 602, a mounting member 604, and a controller 606. The light pattern generator 602 includes a laser light source 612, a beam splitter 614 coupled to the laser light source 612, and optics that are coupled to the beam splitter 614. The optics 616 include fiber optic cabling 618 coupled at one end to the beam splitter 614 and coupled at another end to a plurality of diffractive plates 620, 622, and 624. The mounting member 604 includes one or more mounting brackets 608 for mounting the diffractive plates 620, 622, and 624 to a vehicle (not shown). The controller 606 is electrically coupled to the light pattern generator 602 and controls power thereto.

The laser light source 612 generates laser light, which is split by the beam splitter 614. The fiber optic cabling 618 carries the split laser light from the beam splitter 614 to the diffractive plates 620, 622, 624 from which a pattern 626 of spaced images 628 are projected on the ground 630. As shown in FIG. 6A, the plurality of diffraction plates 620, 622, and 624 may be mounted in spaced relation and a different angles with respect to each other and with respect to the light pattern generator 602. The embodiment of the device 600 shown in FIG. 6A may be particularly useful if space constraints of the vehicle in which the illumination device 600 is to be mounted make it difficult to co-locate all of the components of the illumination device 600 together, as is the case for device 500. For example, a passenger vehicle may not have adequate space to house the entirety of device 500 in its trunk area, but may have room to house the diffractive plates 620, 622, and 624 in the trunk area and the laser light source 612 and the beam splitter in the engine or passenger compartment of the car. Therefore, the use of the fiber optic cabling 618 to space the diffractive optics from the rest of the light pattern generator 602 may facilitate integration of the device 600 in more constrained spaces, such as smaller vehicles.

The device 600 shown in FIG. 6A may also be modified to incorporate a fiber optic terminal block and a rotating diffractive plate mounting. In one embodiment shown in FIG. 6B, a device 650 includes a light pattern generator 652, a mounting member 654, and a controller 656. The light pattern generator 652 includes a laser light source 662, a beam splitter 664 coupled to the laser light source 662, and optics 666 that are coupled to the beam splitter 664. The optics 666 include fiber optic cabling 668 coupled at one end to the beam splitter 664 and coupled at another end to a fiber optic terminal block 670 and a diffractive plate 672 having a diffractive grating. The fiber optic terminal block 670 is configured to optically couple the fiber optic cabling 668 with the diffractive grating of the diffractive plate 672. A motor 674 may be coupled to the diffractive plate 672 for rotating the diffractive plate 672 in front of the terminal block 670 so that light pattern 676 projected by light emitted from the diffractive plate 672 change by falling into and out coherence, thereby giving the visual impression that the images 678 of the light pattern 676 change and spin. Specifically, the projected images 678 may move into and out of each other in such a way that it is eye-catching to an observer.

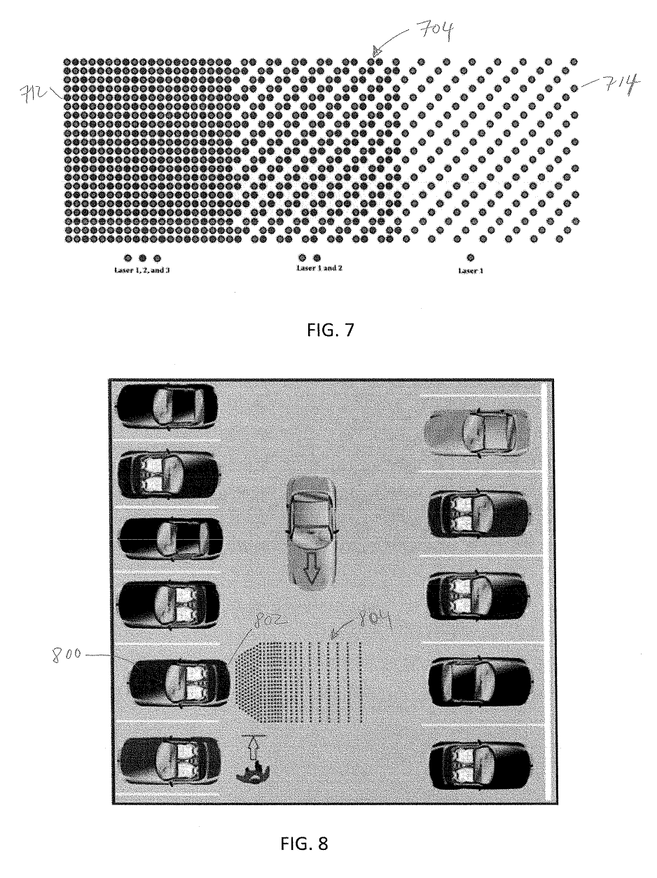

In one embodiment, multiple light pattern generators, like generator 502 in FIG. 5A using a plurality of lasers 512, may be used to generate and project multiple image arrays on the ground. The multiple arrays, projected together, may be combined by overlaying the arrays to form a single combined light pattern on the ground, as shown for example in FIG. 7. FIG. 7 shows a light pattern 704 produced by multiple light pattern generators, such as generator 502, that are positioned at various angles and/or with progressively wider projection angles or using wider diffraction plates, so that together the generators generate multiple arrays of images on the ground, thereby creating the mixed image pattern 704 that has a high image density towards a first end 712 of the pattern 704 and a lower image density towards the second end 714 of the pattern 704.

The controllers 506 and 606 of FIGS. 5 and 6 may include a power switch and/or sensor. The power switch may turn on the respective light pattern generators 502 and 602 automatically when the vehicle is shifted into reverse, for example. The controllers 506 and 606 may also include a timer circuit that prevents the respective light pattern generators 502 and 602 from turning on every time a driver shifts directly into drive gear and that requires the vehicle to be operating in reverse for at least a predetermined amount of time, such as 0.5 to 1 second, prior to turning on. The timing circuit may also include a flashing circuit to turn the respective light pattern generators 502 and 602 on and off repeatedly, such as for fractions of a second. This may be useful to minimize laser radiation output if a laser is used as a light source.

In one embodiment where the illumination warning devices 500 and 600 are installed in a car, the controllers 506 and 606 may be communicatively coupled to the car's back-up sensor package (if present). The controllers 506 and 606 may activate the respective light pattern generators 502 and 602 and place it in a flashing mode when the back-up sensors are activated thus elevating awareness to pedestrian and vehicle traffic around the reversing car. Also, the controllers 506 and 606 may activate a motor to rotate the diffractive plate when the back-up sensors are activated to rotate the lighting pattern projected on the ground behind the vehicle so as to elevate awareness to pedestrian and vehicle traffic around the reversing car. The controllers 506 and 606 may also be configured to supply more power to the respective light pattern generators 502 and 602 when the vehicle's back-up sensor is activated, thus increasing the brightness of the lighting pattern. Also, the controllers 506 and 606 may communicate with ambient light sensors already installed in the vehicle to apply more power to the respective light pattern generators 502 and 602 during daylight and reducing power at night.

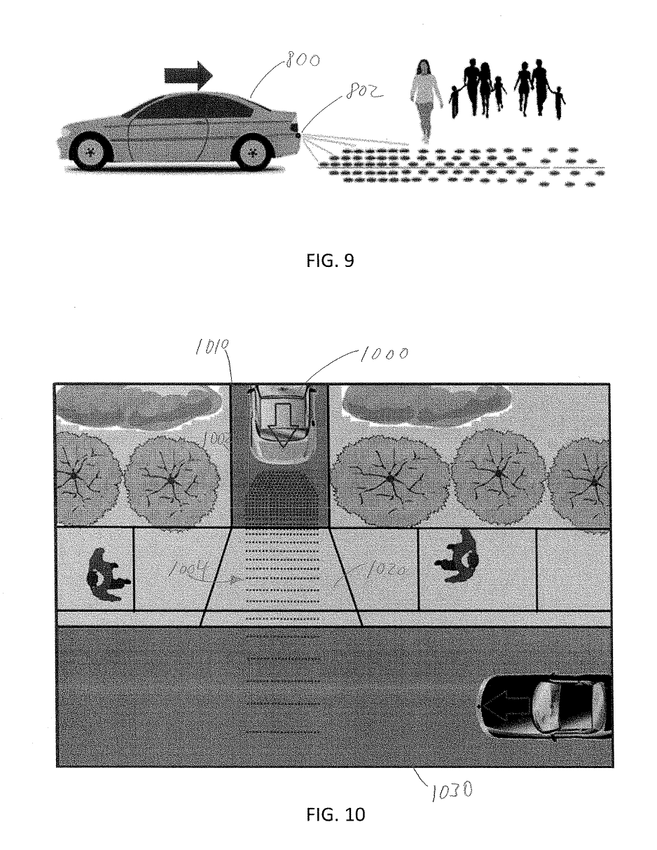

While the embodiments of the optical illumination warning devices have been described primarily with reference to mounting to a fork truck, they may also be mounted in the same manner to passenger vehicles to warn pedestrians and other vehicles, as shown in FIGS. 8 to 10. FIGS. 8 and 9 show a car 800 equipped with an optical illumination warning device 802 backing up in a parking lot. FIG. 10 shows a car 1000 equipped with an optical illumination warning device 1002 backing up from a driveway 1010 along a path that crosses a sidewalk 1020 and a road 1030. In FIGS. 8 to 10, the devices 802 and 1002 respectively project light patterns 804 and 1004 on the ground to warn pedestrians and other vehicles of the proximity of the reversing vehicles 800 and 1000. Also, in FIGS. 8 to 10, a dot pattern is generated that is wider than the width of the car itself.

There have been described and illustrated herein several embodiments of an optical warning illumination device. While particular embodiments of the invention have been described, it is not intended that the invention be limited thereto, as it is intended that the invention be as broad in scope as the art will allow and that the specification be read likewise. Thus, while particular configurations of elements of the optical warning illumination device have been disclosed, it will be appreciated that other configurations exist as well. In addition, while particular types of light sources and optics have been disclosed, it will be understood that other types of light sources and optics may be used. For example, and not by way of limitation, light emitting diodes and projectors may be utilized. Also, while particular light patterns have been shown, it will be appreciated that many other light patterns could be provided. For example, while light patterns have been shown that include columns having a height between the approximately 1.0 times and 1.8 times the width of the vehicle (compare FIG. 3 and FIG. 8), it will be appreciated that the column height could be larger than shown. Also, while row length of the light patterns have been shown to be between approximately 1.0 to 1.8 times the length of the vehicle, it will be appreciated that the row length could be considerably larger than shown. Further, while light patterns have been shown with columns most adjacent the vehicle not extending the full height of most columns further from the vehicle, the columns most adjacent the vehicle could be arranged to have the same column height if desired. Similarly, while light patterns have been shown with columns further away from the vehicle extending the same or similar heights, it will be appreciated that the column height could increase or decrease as a function of distance from the vehicle. It will therefore be appreciated by those skilled in the art that yet other modifications could be made to the provided invention without deviating from its spirit and scope as claimed.

What is claimed is:

1. An optical warning illumination device for a vehicle, comprising:
a light pattern generator for generating and projecting a light pattern on the ground adjacent to the vehicle, wherein said light pattern includes a plurality of unequally spaced images, and wherein spacing between said images increases with increasing distance from the device; and
a mounting member for mounting said light pattern generator to the vehicle and to position said light pattern generator with respect to the vehicle.

2. The optical warning illumination device according to claim 1, wherein:
said light pattern on the ground extends in a direction of travel of the vehicle, from near the vehicle to a predetermined distance away from the vehicle.

3. The optical warning illumination device according to claim 1, wherein:
spacing between images is between 0.1 inch to 72 inches.

4. The optical warning illumination device according to claim 1, wherein:
said projected images have a diameter of at least 0.1 inch.

5. The optical warning illumination device according to claim 1, wherein:
said mounting member is configured to adjust the position of said light pattern generator based on a direction of travel of the vehicle.

6. The optical warning illumination device according to claim 1, wherein:
said light pattern generator projects a plurality of overlapping arrays of images that form said light pattern.

7. The optical warning illumination device according to claim 1, wherein:
said images are arranged as an orthogonal grid that extends in a longitudinal direction parallel to a direction of travel of the vehicle and in a transverse direction perpendicular to the direction of travel of the vehicle, wherein said grid includes a first plurality of transversely extending columns of images, said first plurality of columns being longitudinally spaced apart by a first distance and a second plurality of transversely extending columns of images, said second plurality of columns longitudinally spaced apart by a second distance.

8. The optical warning illumination device according to claim 7, wherein:
said grid includes a third plurality of transversely extending columns of images, said third plurality of columns longitudinally spaced apart by a third distance.

9. The optical warning illumination device according to claim 8, wherein:
the first distance is less than the second distance, and the second distance is less than the third distance.

10. The optical warning illumination device according to claim 1, wherein:
said mounting member includes a motor to move the light pattern generator in response to movement of a steering wheel of the vehicle.

11. The optical warning illumination device according to claim 1, wherein:
said light pattern generator includes a light source and optics optically coupled to said light source.

12. The optical warning illumination device according to claim 11, wherein:
said light source includes a laser having an output between 0.01 mW to 10 W.

13. The optical warning illumination device according to claim 11, wherein:
said optics include at least one diffraction grating.

14. The optical warning illumination device according to claim 13, wherein:
said optics include a rotating lens cap that rotatably supports the diffraction grating allowing the diffraction grating to rotate with respect to the light generator.

15. The optical warning illumination device according to claim 13, wherein:
said optics further includes a beam splitter and fiber optics optically coupled between said laser and said diffraction grating.

16. The optical warning illumination device according to claim 1, further comprising:
a controller for controlling the operation of said light pattern generator, wherein said controller is configured to be coupled to the vehicle to operate said device in a mode based on an operating mode of the vehicle.

17. The optical warning illumination device according to claim 16, wherein:
said controller is configured to be communicatively coupled to at least one of a back-up sensor and ambient light sensor of the vehicle.

18. The optical warning illumination device according to claim 17, wherein:
said controller regulates power output by the light pattern generator based on output of at least one of said back-up sensor and said ambient light sensor.

19. An optical warning illumination device for a vehicle, comprising:
a light pattern generator for generating and projecting a light pattern on the ground, wherein the light pattern is comprised of a plurality of spaced images; and
a mounting member for mounting said light pattern generator to the vehicle and to position said light pattern generator with respect to the vehicle,
wherein said light pattern on the ground extends in a direction of travel of the vehicle from near the vehicle to a predetermined distance, and said images of the light pattern are unequally spaced from one another along the direction of travel, and spacing between images is based on a function of distance from the vehicle.

20. An optical warning illumination device for a vehicle, comprising:
a light pattern generator for generating and projecting a light pattern on the ground, wherein the light pattern is comprised of a plurality of dots arranged in a grid; and
a mounting member for mounting said light pattern generator to the vehicle and to position said light pattern generator with respect to the vehicle, wherein
said light pattern on the ground extends in a direction of travel of the vehicle from near the vehicle to a predetermined distance, and
said dots of the light pattern are unequally spaced from one another along the direction of travel and spacing between images increases with increasing distance from the vehicle.
